(19) United States
(12) Patent Application Publication
(10) Pub. No.: US 2013/0032546 A1
(43) Pub. Date: Feb. 7, 2013

(54) HOT STERILIZATION OF WATER

(71) Applicant: Hans Scheuren, Regensburg (DE)

(72) Inventor: Hans Scheuren, Regensburg (DE)

(73) Assignee: KRONES AG, Neutraubling (DE)

(21) Appl. No.: 13/564,564

(22) Filed: Aug. 1, 2012

(30) Foreign Application Priority Data
Aug. 2, 2011 (DE) 10 2011 080 262.2

(51) Int. Cl. C02F 1/30; C02F 1/04

(52) U.S. Cl. 210/748.01; 210/198.1; 210/177

(57) ABSTRACT

A method for the sterilization of a liquid, specifically of water, comprises the steps of: evaporating at least a part of the liquid, and exposing the evaporated liquid to ionizing radiation, specifically to electrons. An apparatus for the sterilization of a liquid, specifically of water, comprises a sterilization chamber for receiving an evaporated part of the liquid and a source of ionizing radiation, specifically of electrons, for exposing the evaporated part of the liquid to radiation.

### CROSS-REFERENCE TO RELATED APPLICATIONS

This application claims foreign priority benefits under 35 U.S.C. §119(a)-(d) to German patent application number DE 10 2011 080 262.2, filed Aug. 2, 2011, which is incorporated by reference in its entirety.

### TECHNICAL FIELD

The present disclosure relates to a method for the sterilization of a liquid, specifically of water. The disclosure further relates to an apparatus for the sterilization of a liquid, specifically of water.

### BACKGROUND

The sterilization of liquids in the food industry is of great importance. Common methods include, for example, the heating of the liquid to a high temperature so as to eliminate bacteria contained therein. A disadvantage thereof is that the temperatures and time periods required therefor are relatively high and long (e.g., some minutes at 121° C.). Other sterilization methods such as the steam sterilization or hot air sterilization are not suited for use with liquids. Another sterilization method is the exposure to ionizing radiation, either with UV-, X-ray-, gamma radiation, or the electron impact irradiation. The exposure to ionizing radiation requires high radiation energies, however, so as to penetrate deeply enough into the medium to be sterilized.

A method for the decontamination of surfaces on a living creature is known from Document WO02/058742 A1, which is operated with relatively low-energy electrons in an energy range of 40 kV to 60 kV, for example, in order to kill bacteria present on the surface by destroying their cell structure, but without destroying the (skin) surface of the living creature.

### SUMMARY

Given these disadvantages of the prior art, it is an object of the present disclosure to avoid these disadvantages and provide a method and an apparatus by means of which liquids can be sterilized with a comparatively small expenditure of energy.

The aforementioned object is achieved by a method for the sterilization of a liquid, specifically of water, comprising the steps of: evaporating at least a part of the liquid, and exposing the evaporated liquid to ionizing radiation, specifically to electrons. By the evaporation, the liquid is transformed into the vapor state and is then exposed to ionizing radiation (e.g., irradiation with electron beams). Due to the vapor state of the medium/fluid to be sterilized the range of the ionizing radiation is greater than in the liquid state. This reduces the necessary radiant energies (that is, for example, the energy of a single electron) and, thus, also the total expenditure of energy for the sterilization. The evaporation can be carried out, for example, by means of a downflow evaporator.

The advantage of the method is that it takes place very fast because the medium to be sterilized is not heated up, so that by this, and by using ionizing radiation, e.g., electrons from an electron emitter, the method can be carried out with a relatively small expenditure of energy.

According to a further development of the method according to the disclosure, the evaporation step may comprise a flash evaporation. The flash evaporation affords a simple method for carrying out the evaporation. The liquid is introduced into a lower-pressure space, e.g., with the liquid being under an atmospheric pressure as compared to a reduced pressure in the space, so that an at least partial phase transition into the gaseous phase takes place.

According to a further development the method may comprise the additional step of introducing the evaporated liquid into a sterilization chamber, or the flash evaporation step may comprise the introduction of the liquid into a sterilization chamber. Thus, the evaporated liquid is provided for the sterilization, or the liquid can be expanded into a predefined volume in which the liquid can be sterilized in a controlled manner.

The reduction of the pressure in the sterilization chamber may be accomplished before introducing the liquid into the sterilization chamber. The reduction of the pressure in the sterilization chamber can be accomplished, for example, by a pump, which partially sucks off air present in the sterilization chamber, thereby producing a negative pressure. If the pressure is reduced after the introduction, this may also be realized, for example, by a sudden expansion of the volume, for example, by pulling out a movable plunger/piston. By performing the reduction during the introduction the sterilization process can be carried out continuously.

According to a further development the pressure in the sterilization chamber may be lower than the atmospheric pressure, preferably in the range of 20 mbar to 800 mbar, wherein the liquid is introduced into the sterilization chamber at an atmospheric pressure. By this, when entering the sterilization chamber, an evaporation of a large part of the water will take place in the form of an expansion. Due to the low pressure and the transformation of the water from the liquid phase into a vapor state the range of the emitted electrons is greater as under atmospheric conditions. Moreover, the production of ozone is smaller than under atmospheric pressure conditions.

According to a further development, the method may comprise the additional step of condensing the irradiated vapor, specifically by increasing the pressure in the sterilization chamber. Thus, the normal atmospheric pressure is built up again, and the water vapor is condensed to liquid water.

According to a further development of the method, the liquid may be heated prior to the flash evaporation, specifically to a temperature of 20° C. to 60° C. This slight heating allows a reduction of the differential pressure, which is necessary for the flash evaporation, in the sterilization chamber, that is, the pressure necessary in the sterilization chamber can be increased.

According to an alternative further development, the pressure in the sterilization chamber may correspond to the atmospheric pressure, and the liquid can be introduced at a pressure that is greater than the atmospheric pressure. In this case, too, a flash evaporation takes place. However, the atmospheric pressure and the air density in the sterilization chamber associated therewith influence the range of the ionizing radiation.

Another further development of the method according to the disclosure and the further developments thereof is that the additional step of injecting sterile air into the sterilization chamber can be carried out for the removal of ozone, specifically after the irradiation with ionizing radiation. Thus, the ozone produced by the electrons colliding with air molecules can be removed again.

The method can be carried out discontinuously by repeating the respective method steps, or the method can be carried out continuously.

The aforementioned object is further achieved by an apparatus for the sterilization of a liquid, specifically of water, comprising: a sterilization chamber for receiving a flash-evaporated part of the liquid, and a source of ionizing radiation, specifically of electrons, for exposing the flash-evaporated part of the liquid to radiation. The advantages of this apparatus over apparatus for the sterilization of a liquid according to the prior art have already been mentioned in connection with the method according to the disclosure, so that a repetition is waived.

According to a further development the apparatus according to the disclosure may comprise means for reducing the pressure in the sterilization chamber, specifically a liquid ring pump. Thus, an effective means for reducing the pressure is provided.

Another further development is that the apparatus may further comprise a first container for unsterilized liquid, and a pump for conveying the unsterilized liquid into the sterilization chamber. Thus, a receiver tank for the unsterilized liquid is provided.

Another further development of the apparatus is that it may further comprise a second container for sterilized liquid, and a pump for conveying the sterilized liquid from the sterilization chamber into the second container. Thus, a receiver tank for sterilized liquids is provided, from which the sterilized liquid can be withdrawn for further treatment.

Another further development of the apparatus is that means for heating the unsterilized liquid may be provided, such as an electric or gas powered water heater, so that the unsterilized liquid can be heated up, for example to 20° C. to 60° C., so as to be able to perform the flash evaporation process more efficiently.

Other features and exemplary embodiments as well as advantages of the present disclosure will be explained in more detail below by means of the drawings. It will be appreciated that the embodiments do not limit the scope of the present disclosure. It will also be appreciated that some or all of the features described below may also be combined with each other in a different way.

### DESCRIPTION OF THE DRAWINGS

FIG. 1 represents a first embodiment of the apparatus according to the disclosure; and

FIG. 2 represents a second embodiment of the apparatus according to the disclosure.

### DETAILED DESCRIPTION

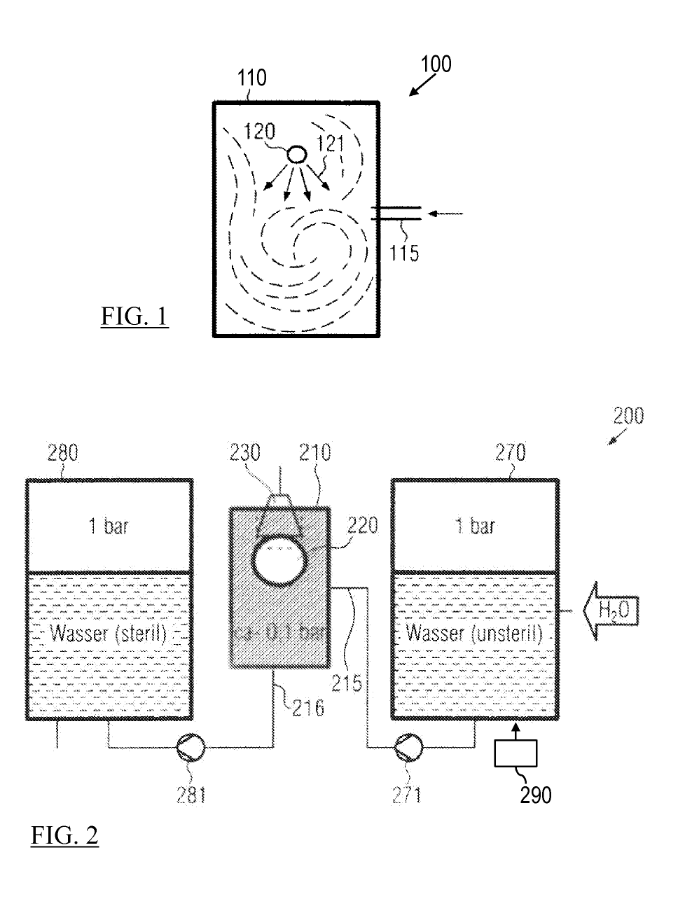

FIG. 1 shows a first embodiment of the apparatus according to the disclosure for the sterilization of a liquid, in this case of water. The apparatus of this embodiment is adapted to obtain an evaporation of the liquid by an expansion of the liquid in a lower-pressure space, i.e., by means of flash evaporation.

The apparatus 100 comprises a sterilization chamber 110 for receiving a flash-evaporated part of the water, and a source 120 of ionizing radiation, in this case of electrons 121, for exposing the flash-evaporated part of the water to radiation. In this case, the water is introduced at atmospheric pressure through an inlet 115 into the sterilization chamber 110. A negative pressure is prevailing in the sterilization chamber 110, so that the water is evaporated by expansion. If the water is introduced under an atmospheric pressure at a temperature, for example, of 30° C., a pressure of about 40 mbar is necessary in the sterilization chamber so as to achieve a flash evaporation of the water as completely as possible. The relationship between the water temperature and the necessary pressure in the sterilization chamber is determined by the person skilled in the art by means of the vapor-pressure diagram known to him.

The electron beams 121 kill germs existing in the water, with a sufficiently great free path length being available to the electrons due to the pressure reduction in the sterilization chamber because the density of the air is reduced correspondingly. The necessary electron energies are in the range of 10 keV to 100 keV (corresponding to the necessary acceleration voltages for the electrons).

FIG. 2 shows a second embodiment of the apparatus according to the disclosure, in this case with a first container 270 for unsterilized water and a second container 280 for sterilized water being provided in addition to the sterilization chamber 210. Unsterilized water is conveyed by a pump 271 from the first container 270 through an inlet 215 in to the sterilization chamber, in which a pressure of about 0.1 bar is prevailing. This pressure or negative pressure, respectively, is generated by a pump 230. Moreover, an electron beam generator 220 is provided in the sterilization chamber 210. Sterilized and re-condensed water is conveyed by pump 281 through an outlet 216 into the second container 280. For the condensation of the sterilized vapors the pressure in the sterilization chamber is raised again to atmospheric pressure, and is reduced again after the sterilized water has been pumped out, so that another cycle may follow.

The method and the apparatus according to the disclosure allow a sterilization of process water with a small input of thermal energy, and with the use of an electron emitter. The water to be sterilized is heated by a heating device 290 (e.g., an electric or gas powered water heater), for example to about 40° C., and expanded from an ambient pressure to a corresponding negative pressure of about 40 mbar. This pressure change results in an evaporation of the water, wherein the generation of the negative pressure may be accomplished in an energy-efficient manner by using a liquid ring pump. This process is free from chemicals and of a purely physical nature. Upon the completion of the irradiation the sterile vapor is brought back to a normal pressure, followed by an immediate condensation. After the sterilization, possible ozone produced in a low concentration only due to the oxygen deficiency in the treatment chamber can be removed by injecting sterile air. Furthermore, the released condensation heat can be recovered as evaporation enthalpy.

Processed water having a temperature of 20° C. to 60° C. is fed into the container shown on the right side of FIG. 2. Higher temperatures are possible, too. By means of the pump the water is conveyed into the negative pressure chamber for treatment. Depending on the temperature, the prevailing pressure ranges from 20 mbar to 800 mbar so that, upon the entry into the chamber, a greatest possible evaporation of the water takes place in the form of a flash evaporation. At the same time, or subsequently, the vapor is exposed to radiation by an electron emitter. Due to the low air pressure and the transformation of the water from the liquid into a vapor state the range of the emitted electrons is greater than under atmospheric conditions and in the liquid state of the water. Also, the ozone production is minimal.

As an alternative to this, it is possible to expand the water from a positive pressure state to atmospheric pressure. To this end, the water has to be overheated. A disadvantage over the preceding embodiment is that the comparatively high atmospheric pressure reduces the range of the electron beam.

An advantage of the method according to the disclosure is that it can be carried out very fast because no heating is required, and that the use of an electron emitter is possible with a relatively low energy input. The method may be carried out in multiple stages, discontinuously or also continuously.

Moreover, the charged state of the water with germs can be checked on the gas side and the liquid side for the purpose of checking the sterilization degree.

While exemplary embodiments are described above, it is not intended that these embodiments describe all possible forms of the disclosure. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for sterilizing a liquid, the method comprising:
evaporating at least a part of the liquid; and
exposing the evaporated liquid to ionizing radiation.

2. The method according to claim 1 wherein the evaporating step comprises a flash evaporation.

3. The method according to claim 2 wherein the flash evaporation comprises introducing the liquid into a sterilization chamber.

4. The method according to claim 3 wherein pressure in the sterilization chamber corresponds to atmospheric pressure, and the liquid is introduced at a pressure that is greater than the atmospheric pressure.

5. The method according to claim 3 wherein the pressure in the sterilization chamber is reduced lower than atmospheric pressure, and the liquid is introduced at atmospheric pressure.

6. The method according to claim 5 wherein the pressure in the sterilization chamber is reduced to a pressure in the range of 20 mbar to 800 mbar.

7. The method according to claim 1 further comprising introducing the liquid or the evaporated liquid into a sterilization chamber.

8. The method according to claim 7 further comprising reducing pressure in the sterilization chamber, wherein the pressure reduction is accomplished prior to and/or during and/or after the introducing step.

9. The method according to claim 7 further comprising injecting sterile air into the sterilization chamber for the removal of ozone.

10. The method according to claim 1 further comprising condensing the irradiated vapor.

11. The method according to claim 1 wherein the exposing step is performed in a sterilization chamber, and the method further comprises condensing the irradiated vapor by increasing pressure in the sterilization chamber.

12. The method according to claim 1 further comprising heating the liquid prior to the evaporation.

13. The method according to claim 12 wherein the liquid is heated to a temperature in the range of 20° C. to 60° C.

14. The method according to claim 1 wherein the method is carried out discontinuously by repeating the respective method steps, or wherein the method is carried out continuously.

15. The method according to claim 1 wherein the ionizing radiation comprises electrons.

16. An apparatus for sterilizing a liquid, the apparatus comprising:
a sterilization chamber for receiving an evaporated part of the liquid; and
a source of ionizing radiation for exposing the evaporated part of the liquid to radiation.

17. The apparatus according to claim 16 further comprising a device for reducing pressure in the sterilization chamber.

18. The apparatus according to claim 16 further comprising a first container for receiving the liquid as unsterilized liquid, and a pump for conveying the unsterilized liquid into the sterilization chamber.

19. The apparatus according to claim 18 further comprising a second container for receiving the liquid after sterilization, and a pump for conveying the sterilized liquid from the sterilization chamber into the second container.

20. The apparatus according to claim 18 further comprising a heating device for heating the unsterilized liquid.
